(19) United States
(12) Patent Application Publication
(10) Pub. No.: US 2024/0258828 A1
(43) Pub. Date: Aug. 1, 2024

(54) NON-CONTACT POWER SUPPLY DEVICE, NON-CONTACT POWER SUPPLY SYSTEM, ELEVATOR, AND LINEAR CONVEYOR

(71) Applicant: Mitsubishi Electric Corporation, Tokyo (JP)

(72) Inventors: Hidehito YOSHIDA, Tokyo (JP); Tomokazu SAKASHITA, Tokyo (JP)

(73) Assignee: Mitsubishi Electric Corporation, Tokyo (JP)

(21) Appl. No.: 18/564,629

(22) PCT Filed: Jul. 16, 2021
(86) PCT No.: PCT/JP2021/026733

§ 371 Date: Nov. 28, 2023

(51) Int. Cl. H02J 50/10; H02J 50/40

(52) U.S. Cl. CPC H02J 50/10; H02J 50/40; H02J 2310/40

(57) ABSTRACT

A power reception coil of a non-contact power supply device includes a plurality of power reception coil windings arranged along a movement direction of a moving object, and the adjacent power reception coil windings are disposed so as to partially overlap each other. Accordingly, even if a power transmission coil is positioned at a boundary between the power reception coil windings, power supply performance does not decrease. In addition, one power reception coil winding is not opposed to two power transmission coils at a time, and thus a cancellation phenomenon of magnetic fields can be prevented and power can be stably supplied.

### TECHNICAL FIELD

The present disclosure relates to a non-contact power supply device, a non-contact power supply system, an elevator, and a linear conveyor.

### BACKGROUND ART

As one configuration of non-contact power supply technologies for transmitting power through magnetic field coupling between two coils spaced from each other, a non-contact power supply device in which a power reception coil is provided in a moving object and a plurality of power transmission coils are provided along a movement path of the moving object, has been known. When the non-contact power supply device is applied to an elevator, a linear conveyor, or the like, power transmission coils to be driven are switched according to the position of a moving object (a car of the elevator, a movable element of the linear conveyor, or the like), whereby power can be continuously supplied to the moving object.

In the non-contact power supply device in which power is continuously supplied to a load of a moving object by a plurality of power transmission coils, there is a case where the moving object is positioned at a boundary between two power transmission coils. At this time, if difference in output phases of power sources for driving the power transmission coils is generated, a phenomenon that magnetic fields generated by the adjacent power transmission coils cancel each other occurs, and power to be supplied is reduced or power cannot be supplied in some cases. As a method for preventing such a cancellation phenomenon of the magnetic fields, control or the like for synchronizing operations of power transmission circuits is performed.

In Patent Document 1, regarding power transmission coils adjacent to each other along a movement direction of a moving object, a plurality of power transmission sources are controlled such that a period during which a magnetic field generated by one power transmission coil is stronger than a magnetic field generated by another power transmission coil and a period during which the magnetic field generated by the one power transmission coil is weaker than the magnetic field generated by the other power transmission coil alternately appear, irrespective of the movement position of the moving object. With such a configuration, power transmission can be performed in a non-contact manner without synchronizing output phases of a plurality of power transmission circuits.

### CITATION LIST

### Patent Document

Patent Document 1: Japanese Laid-Open Patent Publication No. 2020-88973

### SUMMARY OF THE INVENTION

### Problem to be Solved by the Invention

As described above, in the conventional non-contact power supply device, the phenomenon that the magnetic fields generated by the adjacent power transmission coils cancel each other hampers stable power supply, so that the synchronization control for the power transmission circuits or the like to prevent the cancellation phenomenon of the magnetic fields is performed, leading to increases in cost. With the configuration in the above Patent Document 1, a period during which the magnetic field generated by the power transmission coil is purposely weakened is necessary, and thus the power that can be supplied becomes smaller than a power capacity of a power transmission circuit. Accordingly, the power capacity of the power transmission circuit needs to be designed to be larger than power that the load requires, leading to increases in cost.

The present disclosure has been made to solve the above problem, and an object of the present disclosure is to obtain a non-contact power supply device capable of stably supplying power irrespective of the position of a moving object and output phases of power transmission circuits, and enabling cost reduction with a simple configuration.

Another object of the present disclosure is to obtain a non-contact power supply system, an elevator, and a linear conveyor capable of stably supplying power irrespective of the position of a moving object and output phases of power transmission circuits.

### Means to Solve the Problem

A non-contact power supply device according to the present disclosure includes: a power reception coil that is provided in a moving object so as to be opposed to power transmission coils provided in a movement path and that has a plurality of power reception coil windings; and a plurality of power reception circuits that are respectively connected to the power reception coil windings and that convert AC power outputted from the power reception coils to DC power. The plurality of power reception coil windings are arranged along a movement direction of the moving object and the adjacent power reception coil windings are disposed so as to partially overlap each other.

A non-contact power supply system according to the present disclosure includes the non-contact power supply device according to the present disclosure, a plurality of power transmission coils that are provided with an interval therebetween along a movement path of a moving object and that transmit power to a power reception coil in a non-contact manner, and power transmission circuits that respectively drive the power transmission coils.

An elevator according to the present disclosure includes the non-contact power supply device according to the present disclosure, a car provided so as to be movable up and down in a hoistway, a plurality of power transmission coils that are provided on a wall surface of the hoistway so as to have an interval from each other along a movement path of the car and that transmit power to a power reception coil provided in the car in a non-contact manner, and power transmission circuits that respectively drive the power transmission coils.

A linear conveyor according to the present disclosure includes the non-contact power supply device according to the present disclosure, a movable element that moves along a conveyance rail, a plurality of power transmission coils that are provided with an interval therebetween along the conveyance rail and that transmit power to the power reception coil provided in the movable element in a non-contact manner, and power transmission circuits that respectively drive the power transmission coils.

### Effect of the Invention

In the non-contact power supply device according to the present disclosure, even if the power transmission coil is positioned at a boundary between the power reception coil windings, power supply performance does not decrease, power can be stably supplied irrespective of the position of the moving object and output phases of the power transmission circuits, and cost can be reduced with a simple configuration.

In addition, in the non-contact power supply system, the elevator, and linear conveyor each including the non-contact power supply device according to the present disclosure, power can be stably supplied irrespective of the position of the moving object and output phases of the power transmission circuits.

Objects, features, viewpoints, and effects of the present disclosure other than the above-described ones will be more clarified from the following detailed description made with reference to the drawings.

### BRIEF DESCRIPTION OF THE DRAWINGS

FIG. 1 is a block diagram showing a configuration of a non-contact power supply system according to embodiment 1.

FIG. 2 illustrates a configuration example of the non-contact power supply system according to embodiment 1.

FIG. 3 illustrates the arrangement and dimension relationship between power transmission and reception coils in the non-contact power supply system according to embodiment 1.

FIG. 4 illustrates arrangement examples of the power transmission and reception coils in the non-contact power supply system according to embodiment 1.

FIG. 5 illustrates an arrangement example of power transmission and reception coils in a non-contact power supply system according to a comparative example.

FIG. 6 illustrates a configuration example of a non-contact power supply system according to embodiment 2.

FIG. 7 illustrates another configuration example of the non-contact power supply system according to embodiment 2.

FIG. 8 illustrates a configuration example of an elevator according to embodiment 3.

FIG. 9 illustrates a configuration example of a linear conveyor according to embodiment 4.

### DESCRIPTION OF EMBODIMENTS

### Embodiment 1

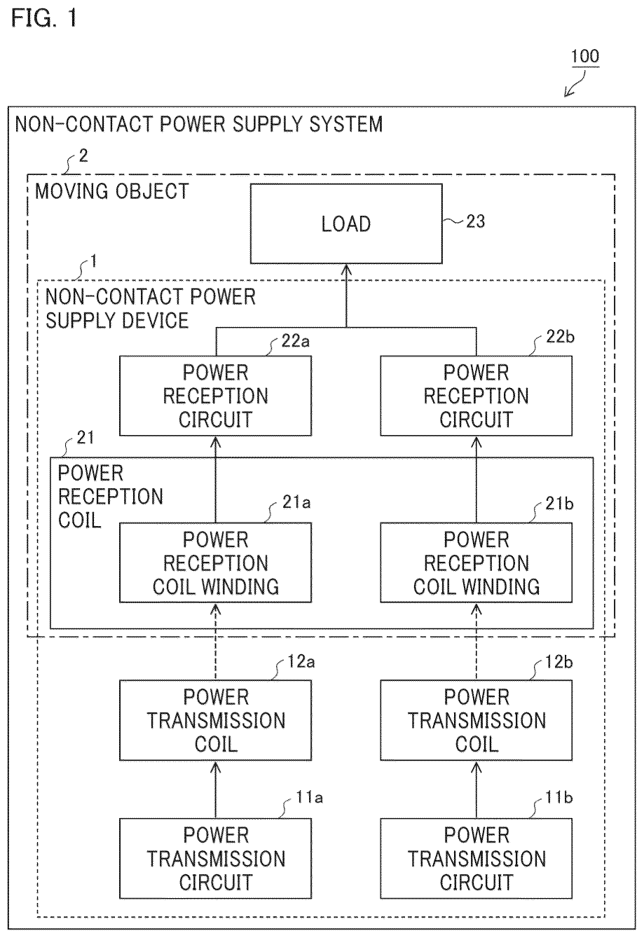

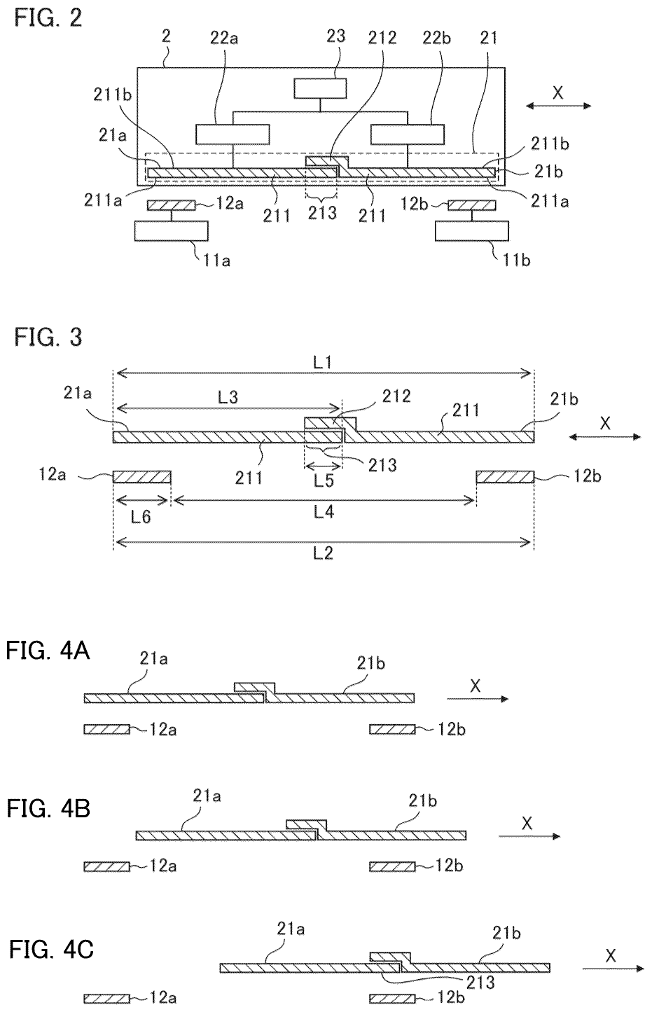

Hereinafter, a non-contact power supply device and a non-contact power supply system according to embodiment 1 will be described with reference to the drawings. FIG. 1 is a block diagram showing a configuration of the non-contact power supply system according to embodiment 1, and FIG. 2 illustrates a configuration example of the non-contact power supply system according to embodiment 1. The same or corresponding portions in the drawings are denoted by the same reference characters.

As shown in FIG. 1, a non-contact power supply system 100 according to embodiment 1 includes: a plurality of power transmission coils 12a, 12b (collectively referred to as power transmission coils 12) provided with an interval therebetween along a movement path of a moving object 2; power transmission circuits 11a, 11b (collectively referred to as power transmission circuits 11) that respectively drive the power transmission coils 12; a power reception coil 21 provided in the moving object 2 so as to be opposed to the power transmission coils 12 according to movement of the moving object 2; and a plurality of power reception circuits 22a, 22b (collectively referred to as power reception circuits 22) that convert AC power outputted from the power reception coil 21 to DC power.

The plurality of power transmission coils 12 are arranged along a movement direction (shown by an arrow X in FIG. 2; hereinafter, referred to as movement direction X) of the moving object 2, and transmit power to the power reception coil 21 in a non-contact manner. In FIG. 2, the moving object 2 is assumed to move in the left-right direction of the drawing sheet, and the power transmission circuits 11a, 11b and the power transmission coils 12 are arranged next to each other in the left-right direction.

In an example shown in FIG. 2, although two power transmission circuits 11 and two power transmission coils 12 are arranged, the numbers thereof are not particularly limited, and necessary numbers of the power transmission circuits 11 and the power transmission coils 12 are arranged in the movement path of the moving object 2. In addition, the ratio of the numbers of the power transmission circuits 11 and the power transmission coils 12 need not be one-to-one, and one power transmission circuit 11 may drive the plurality of power transmission coils 12.

Each power transmission circuit 11 is a power source for outputting high-frequency current or voltage, and drives the power transmission coil 12. A configuration of the power transmission circuit 11 is not particularly limited, and may include a power converter such as an inverter or a DC/DC converter. In addition, an output waveform of the power transmission circuit 11 may be a sinewave of a specific frequency, or may be a waveform having a rectangular wave shape or the like and including a plurality of frequency components.

The power transmission coils 12 respectively include power transmission coil windings, and convert electric energy to magnetic energy and transmit the magnetic energy to the power reception coil 21. The power reception coil 21 receives the magnetic energy from the power transmission coils 12, and converts the magnetic energy to electric energy. Specifically, the power transmission coils 12 and the power reception coil 21 are magnetically coupled with each other (magnetic field coupling), whereby power is transmitted from the power transmission coils 12 to the power reception coil 21 in a non-contact manner. Each power transmission coil 12 may include a magnetic material to enhance a magnetic coupling with the power reception coil 21, and may include a metal shield to block electromagnetic noise.

The non-contact power supply device 1 according to embodiment 1 includes: the power reception coil 21 that is provided in the moving object 2 so as to be opposed to the power transmission coils 12 provided in the movement path and that has a plurality of power reception coil windings 21a, 21b; and the plurality of power reception circuits 22 that are respectively connected to the power reception coil windings 21a, 21b and that convert AC power outputted from the power reception coil 21 to DC power. The plurality of power reception coil windings 21a, 21b are arranged along the movement direction X of the moving object 2, and the adjacent power reception coil windings 21a, 21b are disposed so as to partially overlap each other.

The plurality of power reception circuits 22a, 22b are provided in the moving object 2 and are respectively connected to the plurality of power reception coil windings 21a, 21b. The power reception circuits 22 each have a configuration having four diode connected in a full-bridge form, as an example. The number of the power reception circuits 22 corresponds to the number of the power reception coil windings included in the power reception coil 21. The power reception circuits 22 may each include a filter formed by a capacitor or a reactor to attenuate a high-frequency component included in DC power.

In the present embodiment 1, two power reception coil windings 21a, 21b and two power reception circuits 22a, 22b are provided, but three or more power reception coil windings and three or more power reception circuits 22 may be provided. In addition, the power reception coil windings 21a, 21b may each include a magnetic material to enhance magnetic coupling with the power transmission coil 12, and may include a metal shield to block electromagnetic noise.

A load 23 provided in the moving object 2 is equipment such as a motor or a light that consumes power, and a battery for storing power, and consumes power or stores power, for example. The load 23 may include a filter for eliminating a high frequency on an input side, and may include a power converter for adjusting load voltage.

Next, a configuration of the power reception coil 21 of the non-contact power supply device 1 according to embodiment 1 will be described in detail with reference to FIG. 2. The power reception coil 21 has an overlapped portion 213 at which the adjacent power reception coil windings 21a, 21b partially overlap each other. At this overlapped portion 213, one power reception coil winding 21b is disposed along the other power reception coil winding 21a, at a position farther than the other power reception coil winding 21a from the power transmission coils 12.

The plurality of power reception coil windings 21a, 21b each have a first winding part 211 extending along a common surface 211a parallel to the movement direction X. In FIG. 2, a surface on the power transmission coil 12 side of the first winding part 211 is the common surface 211a.

The one power reception coil winding 21b further has a second winding part 212 extending parallel to the common surface 211a along a surface (e.g., a surface 211b, on a side far from the power transmission coils 12, of the first winding part 211) farther than the common surface 211a from the power transmission coils 12. The second winding part 212 is shorter than the first winding part 211 and is integrated with the first winding part 211.

In the present embodiment 1, the other power reception coil winding 21a is composed only of the first winding part 211. The second winding part 212 of the one power reception coil winding 21b is disposed so as to overlap the first winding part 211 of the other power reception coil winding 21a. The first winding part 211 and the second winding part 212 are parallel or substantially parallel to each other.

Next, the arrangement and dimension relationship between the power transmission and reception coils in the non-contact power supply system according to embodiment 1 will be described with reference to FIG. 3. In FIG. 3, L1 represents the length in the movement direction X of the entire power reception coil 21 including the two power reception coil windings 21a, 21b. 12 represents the sum of a placement interval of the adjacent two power transmission coils 12a, 12b and the lengths in the movement direction X of the two power transmission coils 12a, 12b.

L3 represents the length in the movement direction X of the power reception coil winding 21a. The length in the movement direction X of the power reception coil winding 21b is also the same or substantially the same as L3. L4 represents a placement interval of the adjacent two power transmission coils 12a, 12b, and 15 represents the length in the movement direction X of the overlapped portion 213 of the power reception coil windings 21a, 21b. L6 represents the length in the movement direction X of each power transmission coil 12.

The length L1 in the movement direction X of the power reception coil 21 needs to be not smaller than the sum L2 (i.e., L1≥L2) of the placement interval of the adjacent two power transmission coils 12a, 12b and the lengths in the movement direction X of the two power transmission coils 12a, 12b. In a case where L1 is smaller than L2, when the power reception coil 21 moves, a region that is not opposed to the power transmission coil 12 may occur and power may not be continuously supplied.

The length L3 in the movement direction X of the power reception coil winding 21a needs to be not larger than the placement interval L4 (i.e., L3≤L4) of the adjacent two power transmission coils 12a, 12b. In a case where L3 is larger than L4, a region where the two power transmission coils 12a, 12b are opposed to one power reception coil winding 21a (or 21b) at a time is generated, and power may not be supplied due to a cancellation phenomenon of magnetic fields.

The length L5 in the movement direction X of the overlapped portion 213 of the adjacent power reception coil windings 21a, 21b is preferably equal or substantially equal to the length L6 in the movement direction X of each power transmission coil 12. In a case where L5 is significantly larger than L6, power supply at the overlapped portion 213 is stable, but a use amount of a wire material to be used for the power reception coil windings 21a, 21b is increased, leading to increases in cost. On the other hand, in a case where L5 is significantly smaller than L6, the use amount of the wire material decreases, but the stability of power supply at the overlapped portion 213 may be deteriorated. Therefore, L5 and L6 are preferably designed so as to be substantially equal, from the viewpoint of cost and the stability of power supply.

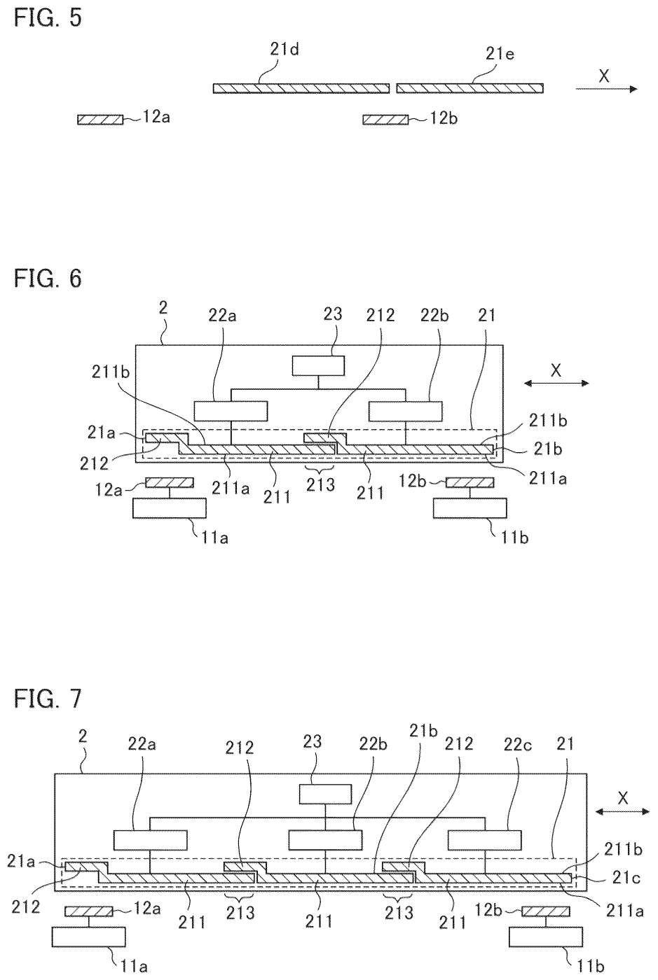

Next, an arrangement example of the power transmission and reception coils in the non-contact power supply system according to embodiment 1 will be described with reference to FIG. 4(a) to FIG. 4(c). As a comparative example, an arrangement example of the power transmission and reception coils in the non-contact power supply system, in which the power reception coil windings have no overlapped portion, is shown in FIG. 5. In the non-contact power supply system 100, the positional relationship between the power transmission coils 12 and the power reception coil 21, which changes according to movement of the moving object 2, can be classified broadly into three as indicated below.

FIG. 4(a) shows a first arrangement, in which two power transmission coils 12 are opposed to the power reception coil 21. In the first arrangement, the power transmission coil 12a is opposed to the power reception coil winding 21a and the power transmission coil 12b is opposed to the power reception coil winding 21b, and the two power reception coil windings 21a, 21b can respectively receive power from different power transmission coils, the power transmission coils 12a, 12b. Accordingly, magnetic fluxes generated by the two power transmission coils 12a, 12b are not interlinked with one power reception coil winding 21a (or 21b), and thus the cancellation phenomenon of magnetic fields can be prevented.

FIG. 4(b) shows a second arrangement, in which one power transmission coil 12 is opposed to one of the power reception coil windings 21a, 21b. In FIG. 4(b), the power transmission coil 12b is opposed to the power reception coil winding 21b, which can receive power from the power transmission coil 12b. In the second arrangement, power is supplied from one power transmission coil 12 to one power reception coil winding 21a (or 21b), and this is the same as a general non-contact power supply method, so that any problem does not arise.

FIG. 4(c) shows a third arrangement, in which one power transmission coil 12 is opposed to both the two power reception coil windings 21a, 21b. In FIG. 4(c), the power transmission coil 12b is opposed to the overlapped portion 213 of the power reception coil windings 21a, 21b. In the third arrangement, both the two power reception coil windings 21a, 21b can receive power form the one power transmission coil 12b.

In the non-contact power supply device 1 according to embodiment 1, the two power reception coil windings 21a, 21b have the overlapped portion 213, whereby two magnetic couplings (a magnetic coupling between the power transmission coil 12b and the power reception coil winding 21a, and a magnetic coupling between the power transmission coil 12b and the power reception coil winding 21b, in an example shown in FIG. 4(c)) are prevented from being both weakened. In the third arrangement, either power reception coil winding (21a or 21b) can always receive power, and thus power supply performance does not decrease.

Meanwhile, as in the comparative example shown in FIG. 5, when power reception coil windings 21d, 21e have no overlapped portion and a portion between the two power reception coil windings 21d, 21e is opposed to the power transmission coil 12b, both the magnetic coupling between the power transmission coil 12b and the power reception coil winding 21d and the magnetic coupling between the power transmission coil 12b and the power reception coil winding 21e are weakened, and thus power supply performance may decrease.

As another measure to prevent magnetic coupling from being weakened, it is conceivable that another power reception coil winding is additionally disposed at the same position as the second winding part 212, at the overlapped portion 213 of the power reception coil windings 21a, 21b. However, this measure requires addition of a power reception coil winding and a power reception circuit, leading to increases in cost. Accordingly, a configuration in which the power reception coil windings 21a, 21b have the overlapped portion 213 is more preferable, from the viewpoint of reduction in the number of components and reduction in cost.

As described above, in the non-contact power supply device 1 according to the present embodiment 1, the power reception coil 21 includes the plurality of power reception coil windings 21a, 21b arranged along the movement direction X of the moving object 2, and the adjacent power reception coil windings 21a, 21b are disposed so as to partially overlap each other. Thus, even if the power transmission coil 12 is positioned at a boundary between the power reception coil windings 21a, 21b, either power reception coil winding (21a or 21b) can always receive power and power supply performance does not decrease.

In addition, since one power reception coil winding 21a (or 21b) is not opposed to the two power transmission coils 12a, 12b at a time, the cancellation phenomenon of magnetic fields when magnetic fluxes generated by the two power transmission coils 12a, 12b are interlinked with the one power reception coil winding 21a (or 21b), can be prevented.

Furthermore, control means for inhibiting output of the power transmission circuit or control means and sensor components, etc., for synchronizing movement of the power transmission circuit, as used in the conventional system, are unnecessary, and thus the system can be simplified and cost reduction can be achieved.

According to the present embodiment 1, it is possible to obtain the non-contact power supply system 100 and the non-contact power supply device 1 capable of stably supplying power, irrespective of the position of the moving object 2 and output phases of the power transmission circuits 11, and enabling reduction of cost with a simple configuration.

### Embodiment 2

FIG. 6 and FIG. 7 each show a configuration example of a non-contact power supply system according to embodiment 2. The non-contact power supply system according to embodiment 2 is the same as the non-contact power supply system 100 according to the above embodiment 1 except for the configuration of the power reception coil, and therefore only differences will be described.

In embodiment 2, as shown in FIG. 6 and FIG. 7, a plurality of power reception coil windings 21a, 21b, 21c each have a first winding part 211 extending along a common surface 211a (e.g., a surface on a power transmission coil 12 side of the first winding part 211) parallel to a movement direction X, and a second winding part 212 extending parallel to the common surface 211a along a surface (e.g., a surface 211b on a side farther from the power transmission coil 12, of the first winding part 211) farther than the common surface 211a from the power transmission coil 12.

In an example shown in FIG. 6, a power reception coil 21 has two power reception coil windings 21a, 21b, and the second winding part 212 of one power reception coil winding 21b is disposed along the first winding part 211 of the other power reception coil winding 21a to form an overlapped portion 213. In addition, no power reception coil winding is adjacent to the second winding part 212 of the other power reception coil winding 21a, and thus an overlapped portion is not formed. The power reception coil windings 21a, 21b have the same shape or substantially the same shape, and the same configuration or substantially the same configuration.

In an example shown in FIG. 7, the power reception coil 21 has three power reception coil windings 21a, 21b, 21c, and the power reception coil windings 21a, 21b, 21c are respectively connected to power reception circuits 22a, 22b, 22c one-to-one. The power reception coil windings 21a, 21b, 21c have the same shape or substantially the same shape, and the same configuration or substantially the same configuration. According to the configuration in FIG. 7, a range in which power can be received is increased compared to that in FIG. 6, and thus the placement interval of the two power transmission coils 12a, 12b is widened. The number of the power reception coil windings included in the power reception coil 21 is not particularly limited, and may be four or more.

According to embodiment 2, in addition to the same effect as that in the above embodiment 1, a plurality of power reception coil windings have common shapes and configurations, and thus the length in the movement direction of the power reception coil 21 can be easily increased. In addition, a common production process can be used for the power reception coil windings, and thus the production cost can be reduced. Furthermore, a power receiving range becomes extendable, and an individual design of a power reception coil according to requirements for each power receiving range is easy or unnecessary, thereby reducing design costs.

### Embodiment 3

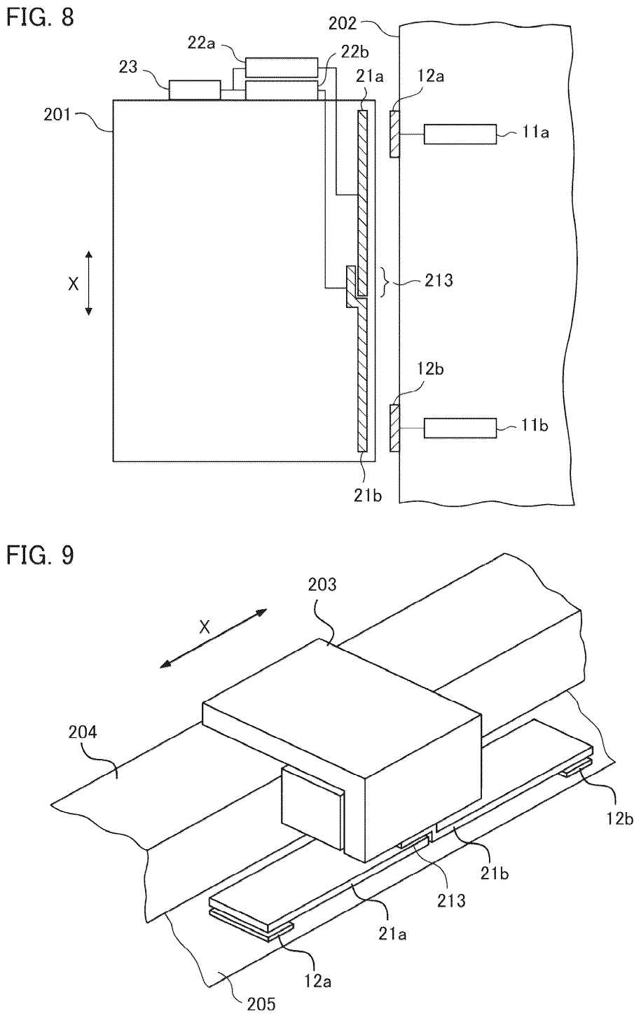

FIG. 8 shows a configuration example of an elevator according to embodiment 3. The elevator according to embodiment 3 includes the non-contact power supply device 1 (see FIG. 1 and FIG. 2) according to the above embodiment 1, and a car 201 as a moving object 2 provided so as to be movable up and down along a plurality of story floors in a hoistway.

In addition, the elevator includes a plurality of power transmission coils 12 provided with an interval therebetween along a movement path of the car 201, and power transmission circuits 11 that respectively drive the power transmission coils 12. As shown in FIG. 8, power transmission circuits 11a, 11b and power transmission coils 12a, 12b are provided at a wall surface 202 of the hoistway. The power transmission coils 12 transmit power to a power reception coil 21 provided in the car 201 in a non-contact manner.

The car 201 includes the power reception coil 21 (see FIG. 2) having power reception coil windings 21a, 21b, power reception circuits 22a, 22b, and a load 23. The power reception coil 21 is provided so as to be opposed to the power transmission coils 12 according to movement of the car 201. The load 23 in the elevator is, for example, lighting equipment, air conditioning equipment, or the like used in the car 201.

The power reception coil 21 includes a plurality of the power reception coil windings 21a, 21b arranged along a movement direction X of the car 201, and the adjacent power reception coil windings 21a, 21b are disposed so as to partially overlap each other. At an overlapped portion 213 of the adjacent power reception coil windings 21a, 21b, one power reception coil winding 21b is disposed along the other power reception coil winding 21a, at a position farther than the other power reception coil winding 21a from the power transmission coils 12.

The arrangement and dimension relationship between the power transmission and reception coils in the non-contact power supply device 1 is the same as that in the above embodiment 1, and therefore the description thereof is omitted (see FIG. 3). The elevator according to the present embodiment 3 includes the non-contact power supply device 1 according to the above embodiment 1, but may include the non-contact power supply device 1 according to the above embodiment 2.

According to embodiment 3, it is possible to obtain the elevator capable of stably supplying power irrespective of the position of the car 201 and output phases of the power transmission circuits 11, by having the non-contact power supply device 1.

### Embodiment 4

FIG. 9 shows a configuration example of a linear conveyor according to embodiment 4. The linear conveyor according to embodiment 4 includes the non-contact power supply device 1 according to the above embodiment 1, a movable element 203 that moves along a conveyance rail 204, a plurality of power transmission coils 12a, 12b provided with an interval therebetween along the conveyance rail 204, and the power transmission circuits 11 (see FIG. 2) that respectively drive the power transmission coils 12.

The power transmission coils 12 transmit power to a power reception coil 21 (see FIG. 2) provided in the movable element 203 in a non-contact manner. The power transmission circuits 11 and the plurality of power transmission coil 12a, 12b are, for example, mounted to a floor surface 205 below the conveyance rail 204. The power reception coil 21 is mounted to the lower portion of the movable element 203, so as to be opposed to the power transmission coils 12 according to movement of the movable element 203. Power reception circuits 22 (see FIG. 2) and a load 23 (see FIG. 2) are loaded on the movable element 203. The load 23 in the linear conveyor is, for example, a device for holding a conveyance object, an assembly robot, or the like.

The power reception coil 21 includes a plurality of power reception coil windings 21a, 21b arranged along the movement direction X of the movable element 203, and the adjacent power reception coil windings 21a, 21b are disposed so as to partially overlap each other. At the overlapped portion 213 of the adjacent power reception coil windings 21a, 21b, one power reception coil winding 21b is disposed along the other power reception coil winding 21a, at a position farther than the other power reception coil winding 21a from the power transmission coils 12.

The arrangement and dimension relationship between the power transmission and reception coils in the non-contact power supply device 1 is the same as that in the above embodiment 1, and therefore the description thereof is omitted (see FIG. 3). The linear conveyor according to the present embodiment 4 includes the non-contact power supply device 1 according to the above embodiment 1, but may include the non-contact power supply device 1 according to the above embodiment 2.

According to embodiment 4, it is possible to obtain the linear conveyor capable of stably supplying power irrespective of the position of the movable element 203 and output phases of the power transmission circuits 11, by having the non-contact power supply device 1.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 non-contact power supply device
2 moving object
11, 11a, 11b power transmission circuit
12, 12a, 12b power transmission coil
21 power reception coil
21a, 21b, 21c, 21d, 21e power reception coil winding
22, 22a, 22b, 22c power reception circuit
23 load
100 non-contact power supply system
201 car
202 wall surface
203 movable element
204 conveyance rail
205 floor surface
211 first winding part
211a common surface
211b surface
212 second winding part
213 overlapped portion

1.-11. (canceled)

12. A non-contact power supply device comprising:
a power reception coil that is provided in a moving object so as to be opposed to power transmission coils provided in a movement path, and that has a plurality of power reception coil windings; and
a plurality of power reception circuits that are respectively connected to the power reception coil windings, and that convert AC power outputted from the power reception coil to DC power, wherein
the plurality of power reception coil windings are arranged along a movement direction of the moving object,
the adjacent power reception coil windings are disposed so as to partially overlap each other,
at an overlapped portion of the adjacent power reception coil windings, one of the power reception coil windings is disposed along another of the power reception coil windings, at a position farther than the other power reception coil winding from the power transmission coils,
the plurality of power reception coil windings each have a first winding part extending along a common surface parallel to the movement direction, and
the one power reception coil winding further has a second winding part extending parallel to the common surface, along a surface farther than the common surface from the power transmission coils.

13. The non-contact power supply device according to claim 12, wherein
the second winding part of the one power reception coil winding overlaps the first winding part of the other power reception coil winding in a direction perpendicular to the movement direction.

14. The non-contact power supply device according to claim 12, wherein
the plurality of power reception coil windings each have a first winding part extending along the common surface parallel to the movement direction, and the second winding part extending parallel to the common surface, along the surface farther than the common surface from the power transmission coils.

15. The non-contact power supply device according to claim 14, wherein the plurality of power reception coil windings have the same shape.

16. The non-contact power supply device according to claim 12, wherein
a length in the movement direction of the power reception coil is not smaller than a sum of a placement interval of the adjacent two power transmission coils and lengths in the movement direction of the two power transmission coils.

17. The non-contact power supply device according to claim 12, wherein
a length in the movement direction of the power reception coil winding is not larger than the placement interval of the power transmission coils.

18. The non-contact power supply device according to claim 12, wherein
a length in the movement direction of the overlapped portion of the adjacent power reception coil windings is equal to the length in the movement direction of each of the power transmission coils.

19. A non-contact power supply system comprising:
the non-contact power supply device according to claim 12;
a plurality of power transmission coils that are provided with an interval therebetween along a movement path of a moving object and that transmit power to the power reception coil in a non-contact manner; and
power transmission circuits that respectively drive the power transmission coils.

20. An elevator comprising:
the non-contact power supply device according to claim 12:
a car provided so as to be movable up and down in a hoistway:
a plurality of power transmission coils that are provided on a wall surface of the hoistway so as to have an interval from each other along a movement path of the car, and that transmit power to the power reception coil provided in the car in a non-contact manner; and
power transmission circuits that drive the power transmission coils.

21. A linear conveyor comprising:
the non-contact power supply device according to claim 12;
a movable element that moves along a conveyance rail;
a plurality of power transmission coils that are provided with an interval therebetween along the conveyance rail, and that transmit power to the power reception coil provided in the movable element in a non-contact manner; and
power transmission circuits that drive the power transmission coils.
